(19) United States
(12) Patent Application Publication
(10) Pub. No.: US 2005/0097519 A1
(43) Pub. Date: May 5, 2005

(54) Apparatus and method for dispositioning signal groups returned by a JTAG scan

(76) Inventors: Lee A. Larson, Katy, TX (US); Henry R. Hoar, Missouri City, TX (US); Huimin Xu, Missouri City, TX (US)

Correspondence Address: TEXAS INSTRUMENTS INCORPORATED, P O BOX 655474, M/S 3999, DALLAS, TX, 75265, US

(21) Appl. No.: 10/943,201

(22) Filed: Sep. 16, 2004

Related U.S. Application Data
(60) Provisional application No. 60/517,579, filed on Nov. 5, 2003.

(51) Int. Cl. G06F 9/44

(52) U.S. Cl. 717/124

(57) ABSTRACT

In a JTAG test and debug environment, a test signal group from the target processor is provided with a status field. The status field is compared with the expected status field. In response to this comparison, the fixed signal groups are stored in a first storage unit, expected signal groups are stored in a second storage unit, and other signal groups are stored in a third storage unit. The status field of the signal group transferred from the target processor permits the analysis of the transferred signal group by the test and debug unit.

This application claims priority under 35 USC §119(e)(1) of Provisional Application No. 60/517,579 (TI-36185P) filed Nov. 05, 2003.

### 1. FIELD OF THE INVENTION

This invention relates generally to the use of emulation units to perform test and debugging operations on a digital signal processor target system and, more particularly, to providing a method for optimizing JTAG (Joint Test Action Group) transfers between a test and debug unit and target processor. The present invention improves the performance of the test and debug unit in boundary scans.

### 2. BACKGROUND OF THE INVENTION

In the past, debugging digital signal processors was done using a scan controller that converts parallel information from a debug unit into a serial data stream, the serial data being sent to the target processor. The target processor can also return a serial data stream, which the scan controller converts back into parallel words which the debug unit processes. The data values returned were either constrained, so only the expected data value was returned, or identified by some sort of data type field, embedded in the returned data stream.

Constraining the data value to a fixed type, eliminates the problem of identifying the type of data returned, but requires multiple scans for all possible data types in order to insure that all data to be returned from the digital signal processor is scanned out. An alternative is to scan out a data available word, identifying all available data values ready to scan out, thus eliminating the scans which do not have data ready to scan out. The disadvantage of this approach is that a separate scan for the data available word must be performed on a regular basis.

Returning a data type field with each data word allows the digital signal processor to return data values asynchronously to the scan commands being sent to it by the scan controller. This approach, while more complex, supports multiple simultaneous communication channels with the digital signal processor. If the scan controller does not receive the expected data type, the data value and type returned are stored for processing by another communication channel and the original scan is retried until it is successful.

The scanning out of unsolicited data by the digital signal processor in response to a scan command causes the debug unit to read the value returned, along with the data type and determine if the data value was the intended response of a value for another communication channel. This increases the software overhead and complexity for each scan, lowering the debug system performance.

Referring to FIG. 1, a block diagram of a test and debug system capable of advantageously using the present invention is shown. The test and debug system includes a user interface 5, a test and debug unit 10, and a target processor 15. The user interface 5 includes the apparatus that permits a user to interact with, and control the testing of, the target processing unit 15. The user interface 5 can include display apparatus, input apparatus such as a keyboard, etc. for initiating test and debug procedures and for receiving the results of these procedures. The user interface 5 is coupled to the test and debug unit 10 through interface unit 101. The interface unit 101 exchanges signals with the processing unit 102 of the test and debug unit 10. The processing unit 102 applies signals to and receives signals from the scan control unit 103. The scan control unit 103 includes a local processor 1031, and memory unit out 1032 for exchanging signals with the local processor 1031, a memory unit in 1035 for storing signals from the target processing unit 15, a shift register out 1034 and a shift register in 1033, the shift registers 1033 and 1034 transferring data in and out of the test and debug unit 10 under control of the local processor 1031. For purposes of the present invention, the processing unit 102 provides commands to the scan control unit 103 and supplies the contents of the memory unit 1032. The target processing unit 15 includes a test access port 151, a shift register 152, an instruction register 153, a data register 154 a mini-status register 155, and a data register 156. The test access port 151 is a state machine responsive to Test Mode Select (TMS) signals from the processing unit 102 for controlling the JTAG apparatus in the target processing unit 15. The shift register 152 receives signals from the shift register out 1034 and transfers signals to the shift register in 1033. The shift register 152 applies signals to the instruction register 153 and with the data register 154 and receives signals from the mini-status register 155 and the data register 156.

Referring to FIG. 2, a portion of the contents of the memory unit out 1032, according to the prior art, is illustrated. In particular, the memory unit out 1032 includes a command parameter section 1032A. Examples of the parameters included in the command parameter section are parameters defining a JTAG initial states and parameters defining JTAG end states. A command from the processing unit 102 will include reference to these parameters and these parameters will be accessed and appropriate control signals applied to the test access port 151 by the local processor.

Referring to FIG. 3, the execution of a command is illustrated. When command A is issued, the command active signal is activated. The command active signal allows the go to shift state function, the send/receive function, and the go to end state to be executed by the scan control unit 103. When the command active signal is no longer active, then a next command B can be executed. If a command C is issued while the target processor is still executing command A, command C will fail and be must retried.

In the past, configurations employing a JTAG emulation unit to test and debug a digital signal processor have had to issue a transaction, such as a read memory command, and then issue additional commands to retrieve the data or to determine if the original transaction was successful. The delay between the commands was usually sufficient to allow the target system the opportunity to complete the transaction. Transactions are usually initiated when the JTAG state (machine) transitions through “Update IR” to “Idle” or Pause. (The state diagram for the JTAG test and debug procedure is shown in FIG. The four stable, non-shift JTAG states are indicated in this Figure as states 41, 42, 43 and 44.) New transactions are initiated by entering the “Scan” state. When the target system does not respond in a timely manner, the transaction will fail, and the test and debug unit 10 must retry the transaction. The transaction retries impact the performance of the test and debug configuration and, in the situation involving large data transfers with many retries, can result in a significant degradation of the configuration performance.

A need has been felt for apparatus and an associated method having the feature of being able to improve the performance of the transfer of the signal groups between a test and debug unit and a target processor. It is yet another feature of the apparatus and associated method to disposition a plurality of signal groups being transferred from a target processing unit to the test and debug unit. It is yet another feature of the apparatus and associated method to separate fixed signal groups, expected signal groups, and other signal groups transferred from a target processor to a test and debug unit. It is a more particular feature of the apparatus and associated method to provide a storage unit for each of the signal groups, the fixed signal groups, the expected signal groups, and the other signal groups.

### SUMMARY OF THE INVENTION

The aforementioned features are accomplished, according to the present invention, by including a status field in signal groups transferred from the target processor as a result of JTAG scan procedure. In addition, software program provides an expected status for the signal groups transferred from the target processor as the result of the JTAG scan procedure. Depending on the status field of the transferred signal group, the signal groups are placed in one of three storage units. Fixed signal groups are stored in one storage unit, expected signal groups are stored in a second storage unit and other signal groups, along with the status field, are stored in the third storage unit. The test and debug processing unit can analyze the results of the scan procedures based on the results stored in the storage units. The contents of the third storage unit can also be used to analyze the operation of the target processing unit, the status field permitting identification of the origin of the signal groups.

Other features and advantages of present invention will be more clearly understood upon reading of the following description and the accompanying drawings and the claims.

### BRIEF DESCRIPTION OF THE DRAWINGS

FIG. 1 is a block diagram of prior art test and debug apparatus capable of advantageously using the present invention.

FIG. 2 illustrates the contents of the scan controller memory unit according to the prior art.

FIG. 3 illustrates the execution of a command in the JTAG test and debug environment according to the prior art.

FIG. 4 is a JTAG state diagram according to the prior art.

FIG. 5A illustrates structure of the memory unit in along with associated apparatus according to the present invention; while FIG. 5B illustrates the structure of signal groups from the target processing unit according to the present invention.

FIG. 6 is flow diagram illustrating the operation of the present invention.

### DESCRIPTION OF THE PREFERRED EMBODIMENT

1. Detailed Description of the Figures

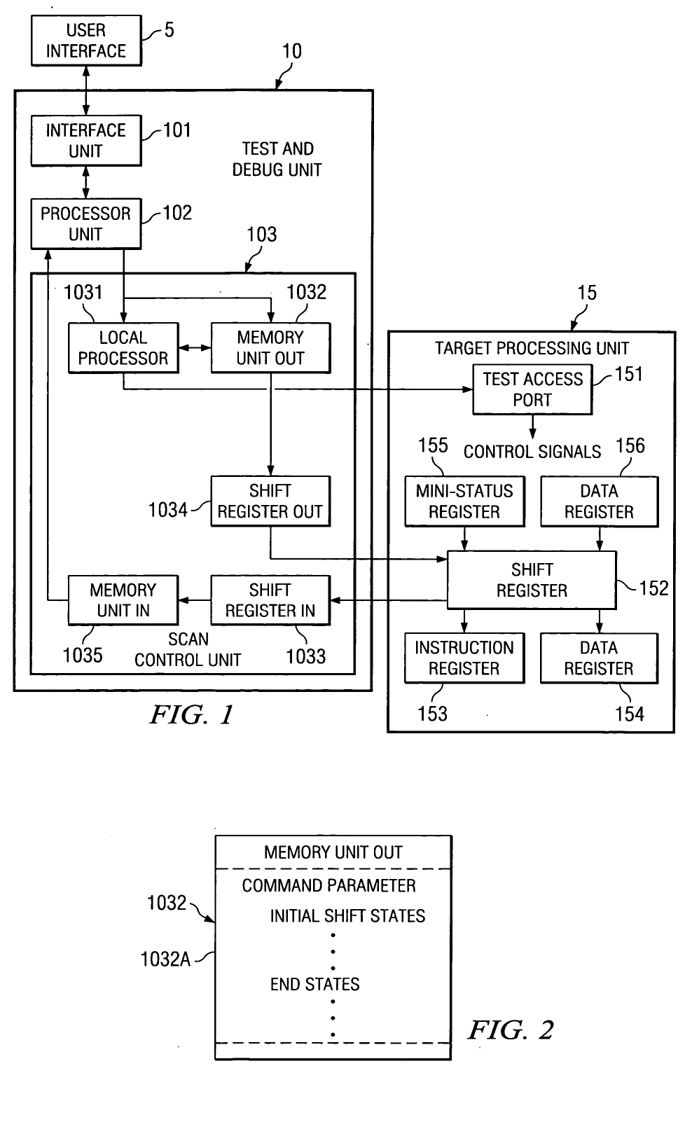

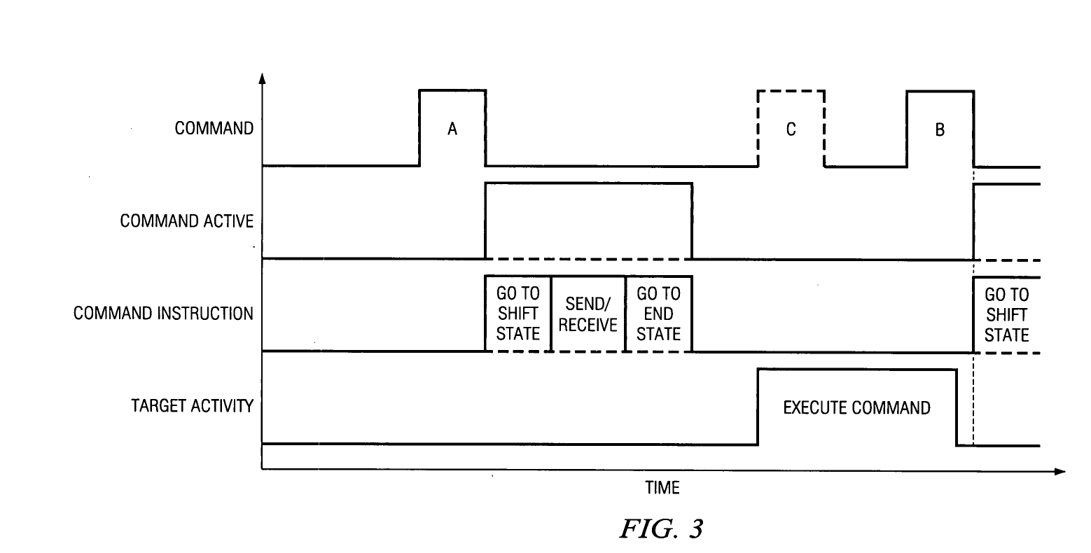

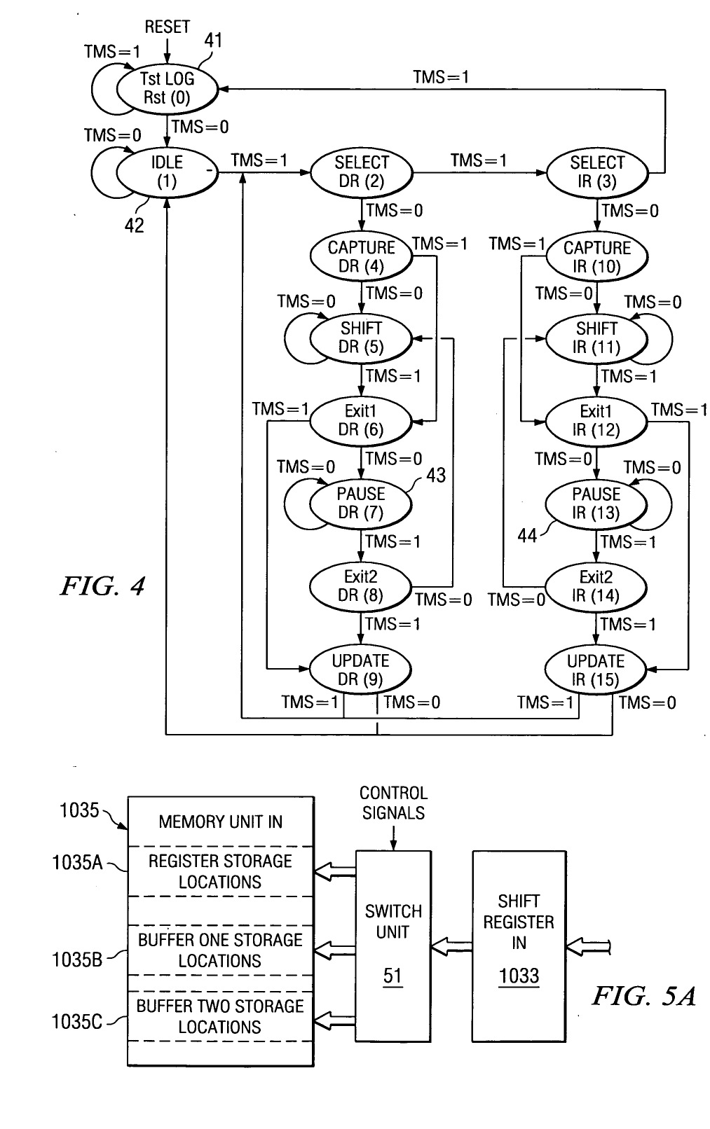

FIGS. 1, 2, 3, and 4 have been described with respect to the related art.

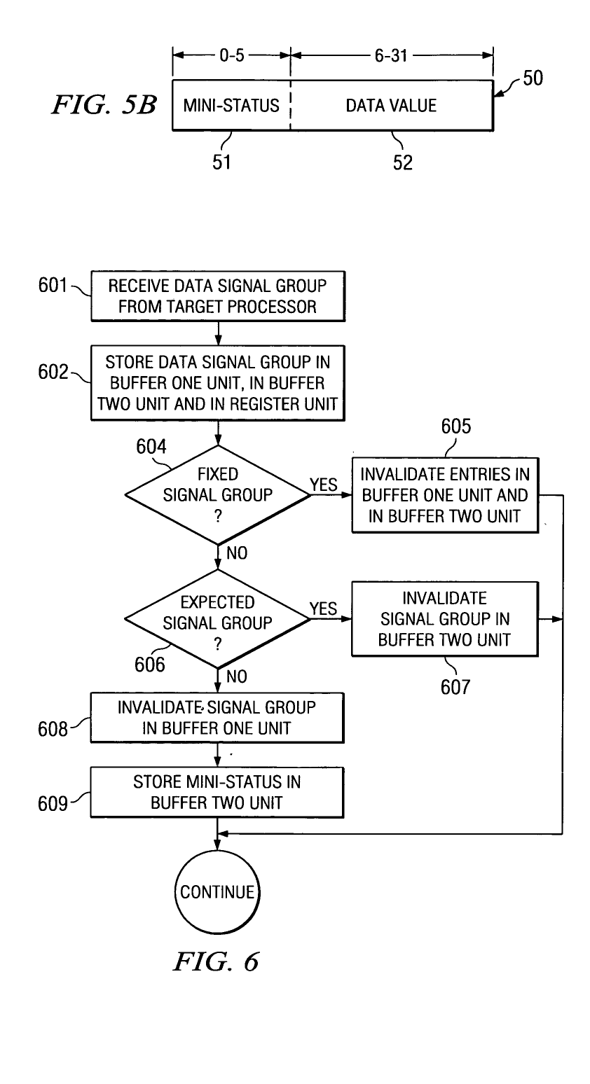

Referring next to FIG. 5A, the memory unit in 1035 and associated apparatus. According to the present invention, is shown. As a result of a JTAG operation, signal groups are shifted into shift register in 1033. The signal groups are transferred to switch unit 51 and, in response to control signals, directed to portions of the memory unit in 1035. The signal groups can allocated to three portions of memory unit in 1035. The first storage portion of the memory unit in 1035 includes the register storage unit locations 1035A. The second storage portion of the memory unit in 1035 includes the buffer one storage locations 1035B. The third storage portion of the memory unit in 1035 includes the buffer two storage locations 1035C.

Referring to FIG. 5B, the format of the signal groups 50 returned from the target processing unit is shown. The signal group 50 includes a mini-status portion 51 identifying the characteristics of the signal group transmitted therewith. The signal group 50 also includes the data value 52 or the signal group itself.

Referring to FIG. 6, the operation of the present invention in storing signal groups in the memory unit in 1035 is described. In step 601, a signal group is received by the shift register in portion of the scan control unit from the target processing unit. The signal groups are stored in the buffer one unit, the buffer two unit, and in the register unit in step 602. In step 603 identified, the mini-status field describing selected characteristics of the signal group is received by the scan control unit. In step 604, a determination is made whether the signal group is a fixed signal group. When the signal group is a fixed signal group, then in step 605 the signal groups stored in the buffer one unit and the buffer two are invalidated and process continues, i.e., the fixed signal groups is transferred to the test and debug processing unit. When the mini-status field indicates that the received signal group is not a fixed signal group, then a determination is made in step 606 whether the signal group is an expected signal group. When the received signal group is the expected signal group, then in step 607 the signal group in the buffer two is invalidated and the process is continued. When the received signal group is not the expected signal group in step 606, then the signal group in buffer one is invalidated and the mini-status field is stored with the received signal group in the buffer two unit.

2. Operation of the Preferred Embodiment

In the preferred embodiment, the memory unit in includes two buffers hold the data values returned and a set of fixed (four 16-bit registers) implemented as part of a RAM. The invention allows the software to select the desired type of data expected to be received from the target processing unit. When a scan is performed, the digital signal processor returns a 32-bit data value and a 6-bit mini-status which identifies the type of data returned.

The data value is returned first and gets stored in the fixed registers and is also written to both buffers. When the mini-status value is returned, the scan control unit hardware invalidates the writes to the buffer the data value does not belong to, possibly both, if the value is supposed to end up in the registers. If the data value is the expected value, the mini-status is discarded. If the data value is not the expected value, the mini-status is stored in the secondary buffer to identify the data type returned.

While the invention has been described with respect to the embodiments set forth above, the invention is not necessarily limited to these embodiments. Accordingly, other embodiments, variations, and improvements not described herein are not necessarily excluded from the scope of the invention, the scope of the invention being defined by the following claims.

1. A test and debug system for testing a target processor, the system comprising:
data transfer apparatus in the target processor to receiving data and for transferring data;
a test access port in the target processor responsive to control signals, the control signals determining the state of the test and debug apparatus in the target processor; and
a scan control unit, the scan control unit including:
a processor responsive to commands for generating the control signals;
at least one register responsive to signals from the processor for exchanging data with the data transfer apparatus;
a storage unit having a plurality of locations, the storage unit storing first signal groups from the one register;
a first buffer storage unit, the first buffer storage unit storing second signal groups from the one register; and
a second buffer storage unit, the second buffer storage unit storing third signal groups from the one register.

2. The system as recited in claim 1 wherein the first signal groups are fixed signal groups, the second signal groups are expected signal groups, and the third signal groups are other signal groups.

3. The system as recited in claim 2 wherein the expected signal group is indicative of the status of the target processor.

4. The system as recited in claim 3 wherein the system operates with a JTAG protocol.

5. In a JTAG test and debug system, a method for transferring signal groups under the control of a scan control unit, the method comprising:
storing first signal groups from a target processor in a plurality of storage units;
storing second signal groups from a target processor in a first buffer unit;
storing third signal groups from a target processor in a second buffer unit.

6. The method as recited in claim 5 wherein a mini-status field is transferred with each signal group, the mini-status field being stored in the second buffer unit when the mini-field identifies another signal group.

7. The method as recited in claim 5 further comprising:
storing each signal group in the plurality of storage units, the first buffer unit, and the second buffer unit;
selecting the signal group in the appropriate unit for further processing.

8. In a JTAG test and debug unit, a scan control unit comprising:
a local processor responsive to at least one command;
a shift register in, the shift register in receiving signal groups a target processor;
a storage unit, the storage unit storing first signal groups from the shift register in;
a first buffer storage unit, the first buffer storage unit storing second signal groups from the shift register in; and
a second buffer storage unit, the second buffer storage unit storing third signal groups from the shift register in.

9. The scan control unit as recited in claim 7 wherein the first signal groups are fixed signal groups, the second signal groups are expected signal groups, and the third signal groups are other signal groups.

10. The scan control unit as recited in claim 8 wherein the signal group is a boundary scan signal group.
